(19) United States
(12) Patent Application Publication
(10) Pub. No.: US 2023/0347396 A1
(43) Pub. Date: Nov. 2, 2023

(54) Method for Biochemical Transformation of Wasteland into Farmland

(71) Applicant: Arpan Jain, Louisville, KY (US)

(72) Inventor: Arpan Jain, Louisville, KY (US)

(73) Assignee: Earths Blue Aura, LLC, Louisville, KY (US)

(21) Appl. No.: 17/731,291

(22) Filed: Apr. 28, 2022

(51) Int. Cl. B09C 1/08

(52) U.S. Cl. CPC B09C 1/08; B09C 2101/00

(57) ABSTRACT

This invention relates to a method for biochemical transformation of wasteland into farmland by filling wasteland using the cellulosic biomass pulp composite cores 1 comprises of a central core portion 2 made up of a dense cellulosic biomass pulp for moisture retention and a shell portion 3 with or without base surrounding the central core portion 2 made up of a cellulosic biomass pulp enriched in phenolic compounds for minimizing interaction of the central core portion 2 with a surrounding soil 4. The dense cellulosic biomass pulp and the cellulosic biomass pulp enriched in phenolic compounds are treated with carbonated water and/or carbon dioxide at the controlled temperature of 0-60° C. The process stabilizes the earthquake-prone zones into stable regions, increases the underground water level, develops the agricultural land, thereby, forestation, develops well-planned green cities, increases crop production, and reduces atmospheric carbon dioxide.

### CROSS-REFERENCE TO RELATED APPLICATIONS

This application is a continuation of and claims priority to U.S. Provisional Application Ser. No. 63/182,035, filed on Apr. 30, 2021. The content of which is hereby expressly incorporated by reference in its entirety.

### STATEMENT REGARDING FEDERALLY SPONSORED RESEARCH

This invention was made without Federal government support.

### FIELD OF THE INVENTION

This invention relates to a method for biochemical transformation of wasteland into farmland by filling wasteland using the cellulosic biomass pulp composite cores made up of a dense cellulosic biomass pulp for moisture retention surrounded by a shell made up of the cellulosic biomass pulp enriched in a phenolic compound for preventing direct contact of the dense cellulosic biomass pulp with the wasteland soil.

### BACKGROUND OF THE INVENTION

The surface of Earth (surface area=5.1×10⁸ km²) surrounds by a thin layer of the ocean surface (surface area=3.6×10⁸ km²) for a stable heat transfer at the outermost surface (crust) from the innermost core (at 6,500° C.). About 71% of the Earth's surface submerges under the ocean. The ocean depths of 5.5 km to 10.8 km (compared to 6,378 km of Earth's radius) function as a buffer region that stabilizes the temperature of the submerged surface at −1° C. Both land and ocean surfaces play critical roles in the earth's surface temperature regulation. Climate change is due to both decreasing levels of underground water and increasing concentration of atmospheric carbon dioxide. Both factors adversely affect the fertility of the topsoil. The high heat capacity of water (4.182 kJ kg⁻¹° C.⁻¹) compared to soil (0.733 kJ kg⁻¹° C.⁻¹) means the temperature of 1 kilogram of water increases slower than the temperature of 1 kilogram of soil (or land). In the case of moisturized soil, the heat capacity would be greater than the soil alone. Furthermore, the absence of water in the topsoil leads to natural calamities, including drought, forest wildfires, and energy-intensive storm formations. The complete absence of underground water in the desert regions (like the Sahara Desert) increases the heat transfer rate which eventually decreases the water precipitation and results in the development of severe sandstorms. The desert areas of the Earth's surface are either naturally evolved (through a seabed) or created (through deforestation).

Sahara Desert is the world's largest desert, with a total area of 9.4×10⁶ km² (equivalent to the USA). In contrast to the Sahara Desert, the maximum ozone synthesis also happens at the equator. It is also believed that with the transformation of a substantial portion of the Sahara Desert (through agriculture), the moving earth's pole shifting can be stabilized. Both the North Pole and the South Pole exist in extremely frigid conditions. The melting of ice significantly affects its existing parameters (temperature due to atmospheric carbon dioxide) for future shifting in the earth's tilted axis. Based on the current scenario, scientists are predicting the stop movement of the Atlantic Ocean's air stream that regulates the weather activities for most nations. The stop movement in the air mass would happen when no cold air mass (during complete melting of ice) fills the vacuum during air movement. In this respect, the biochemical transformation of the western part of the Sahara Desert into farmland reduces the mass flow of stifling air responsible for devastating hurricane formation in the Atlantic Ocean while sequestering the atmospheric carbon dioxide through plant matter and developing the rural communities in the well-planned cities. Climate change (due to global warming) is increasing the severity of the storm's formations both over the surface of the ocean and inland of the land surface and making the storms like Hurricane Florence worst by every year.

Plants and trees (lignocellulosic biomass) play an enormous role in the ecosystem by maintaining a pressure gradient between the land and the sea and recycling atmospheric carbon dioxide (through a photosynthesis process). The presence of these natural resources moisturizes the surrounding area (through a transpiration process) and lowers the heat index of the land. Moreover, the underground root systems of these natural resources minimize soil erosion (during the events of a flood) and maximize soil fertility. The soil moisture content regulates the evaporation rate of underground water and controls the surface temperature at 37° C. (in dense vegetation conditions). In the absence of underground water, hot and dried heat (without moisture) reduces the topsoil's fertility and increases the natural fire events (as in the national forests of California, USA). The absence of these natural resources (plant/trees) in the desert regions also facilitates environmental gas's rapid movement. A recent study by NASA has demonstrated that the flow of atmospheric carbon dioxide in latitudes (from the Tropic of Capricorn to the Tropic of Cancer) occurs due to the overall heat transfer effect. Furthermore, the maximum vegetative growth also occurs between the Tropic of Capricorn and the Tropic of Cancer, providing all essential soil nutrients.

Industrialization has surged atmospheric carbon dioxide from 280 ppm (in the late 1700s) to 417 ppm (at present, 2021). The maximum carbon dioxide concentration of 300 ppm has been noticed over the last 800,000 years of Earth's life. The surge in atmospheric carbon dioxide has created severe drought, flooding, forest fires, and intensive storm formations throughout the globe. Several animal species have been wiped out like never existed before, and many are on the verge of extinction. Before atmospheric carbon dioxide concentration reaches a never-turning back point, it is urgent to solve this crisis for the present and future generations.

Water is the most critical part of a living being. In the absence of freshwater resources, the desalination of seawater performs through membrane and distillation processes. Compared to distillation-based desalination, the membrane-based desalination process requires both high energy and tremendous capital investment. Despite the magnificence of the desalination process, the technology is not efficient in increasing the underground water level.

To be effective in both drought and desert soil remediation, the irrigation of soil should have the maximum water-binding ability for a longer time duration. The process should be self-sustainable. The art is the modification of the soil property that facilitates the germination of a seed in the early phase of its growth while providing a sustainable solution for climate change.

### SUMMARY OF THE INVENTION

Present invention discloses a method for biochemical transformation of wasteland into farmland by filling wasteland with a plurality of cellulosic biomass pulp composite cores using an appropriate method.

The cellulosic biomass pulp composite core is comprised of a central core portion for moisture retention and a shell portion surrounding the central portion for minimizing interaction of the central core portion with the surrounding soil of the wasteland.

The central core portion is made up of a dense cellulosic biomass pulp consisting of about 70-100% cellulose, 0-10% hemicellulose, and 0-10% lignin. The shell portion is made up of a cellulosic biomass pulp enriched in a phenolic compound consisting of about 20-40% cellulose, about 0-10% hemicellulose, and 40-80% phenolic compounds. The pH of the dense cellulosic biomass pulp of the central core portion and the cellulosic biomass pulp enriched in a phenolic compound of the shell portion is maintained in a range of 5-6.5. A lignocellulosic feedstock with a composition of 10-45% cellulose, 10-45% hemicellulose, and 15-35% phenolic compounds (and/or lignin) is used for the production of the dense cellulosic biomass pulp for the central core portion. A lignocellulosic feedstock with a composition of 0-35% cellulose, 0-20% hemicellulose, and 1-80% phenolic compounds is used for the production of the cellulosic pulp enriched in phenolic compounds for the shell portion. The dense cellulosic biomass pulp of the central core portion and the cellulosic biomass pulp enriched in phenolic compounds of the shell portion is treated with carbonated water and/or carbon dioxide at the controlled temperature of 0-60° C. The dense cellulosic biomass pulp of the central core portion may be replaced with a holocellulose pulp consisting of 60-85% cellulose, 10-20% hemicellulose, and 5-15% lignin.

The dimensions of the cellulosic biomass pulp composite core are decided based on a water requirement for the growth of a plant. A volumetric ratio of the central core portion to the shell portion of the cellulosic biomass pulp composite core is taken as 1:1-100:1. The cellulosic biomass pulp composite core is provided with a constant or varying cross-section area of any cross-section shape. The plurality of cellulosic biomass pulp composite cores is filled into the wasteland with its top-end surface in alignment with a soil surface.

The plurality of composite cores may be made up of only the central core portion. Further, the cellulosic biomass pulp enriched in a phenolic compound of the shell portion may be replaced with hydrophobic and/or water-resistant materials such as plastic, PVC, Iron, and steel. The soil of the wasteland may be mixed with the dense cellulosic biomass pulp of the central core portion and the cellulosic biomass pulp enriched in a phenolic compound of the shell portion in a ratio of 1:1 to 1:10,000.

The cellulosic biomass pulp composite cores may be provided with a bottom base for reducing the loss of water from the bottom end surface of the core to the surrounding soil. The cellulosic biomass pulp composite cores may be provided without a bottom base for the formation of inter and intra-connected root systems of the plants and trees grown between different borewells to convert earthquake-prone zones into stable regions due to inter and intra-connected root systems underneath the surrounding soil. The different nutrient contents such as ammonium acetate and potassium chloride are provided through pulp formation of the composite core. The different chemical treatments include and are not limited to alkaline pH (such as ethyl-hydro-oxides (EHOs), alkaline hydroxide (NaOH, KOH, Ca(OH)₂, NH₄OH), alkaline-peroxide, Ionic liquids), acidic pH (sulfuric acid, phosphoric acid, H₂O₂, anthraquinone), and neutral pH (warm, hot, and superheated water) based solvent processes are used for the production of the cellulosic pulp required for the central core portion and the shell portion of the composite core.

The process can be used to make earthquake-prone zones into stable regions, develop well-planned green cities, and increase underground water levels in desert/drought land.

### BRIEF DESCRIPTION OF THE FIGURES

A complete and enabling disclosure of the present subject matter, including the best mode thereof to one of ordinary skill in the art, is set forth more particularly in the remainder of the specification, including reference to the accompanying figures in which:

FIG. 1 demonstrates the development of the plurality of cellulosic biomass pulp composite cores towards wasteland (desert/drought soil) modification into stable land.

FIG. 2 demonstrates the filling of the cellulosic biomass pulp composite core—(a) with base, and (b) without base, towards wasteland (desert/drought soil) modification into stable land.

FIG. 3 demonstrates the borewell equipment for filling of wasteland by the cellulosic biomass pulp composite core—(a) with base and (b) without base, towards wasteland (desert/drought soil) modification into stable land.

FIG. 4 demonstrates the application of the current innovation in the sequestration of atmospheric carbon dioxide and increasing crop productivity.

FIG. 5 demonstrates the process for the biochemical transformation of wasteland into stable land in severe environmental conditions.

Other objects, features, and aspects of the subject matter are disclosed in or are apparent from the following detailed description.

### DETAILED DESCRIPTION OF PREFERRED EMBODIMENTS

Reference will now be made in detail to various embodiments of the disclosed subject matter, one or more examples set forth below. Each embodiment is provided by way of explaining the subject matter, not the limitation of the subject matter. It will be apparent to those skilled in the art that various modifications and variations may be made in the present disclosure without departing from the scope or spirit of the subject matter. For instance, features illustrated or described as part of one embodiment may be used in another embodiment to yield a still further embodiment. Thus, it is intended that the present disclosure cover such modifications and variations as come within the scope of the appended claims and their equivalents.

In general, the present disclosure is directed to a process design that transforms a desert into a stable region, thereby, creating the land surface for agriculture while providing the route for massive forestation. The same process would be utilized in the well-planned city development. In another example, the process would be utilized to irrigate a smaller land surface (less than 100 ha) with a limited water resource. In another example, the process would generate carbon credit. Moreover, the methodology describes the development of a sustainable environment in the desert regions, especially those located between the Tropic of Capricorn to the Tropic of Cancer. During the process (between 3 months to 10 years), the roots of the plants and trees increase the fertility of soil blocks from 0.1 meters to 200 meters deep under the earth's surface. The generated block reduces the heat transfers from both land and air simultaneously, thereby, converting earthquake-prone zones into stable regions.

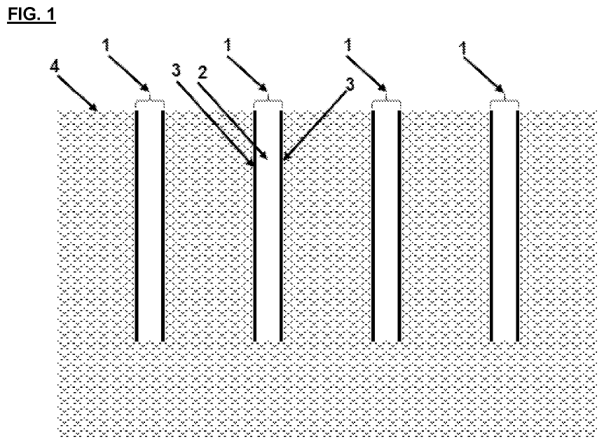

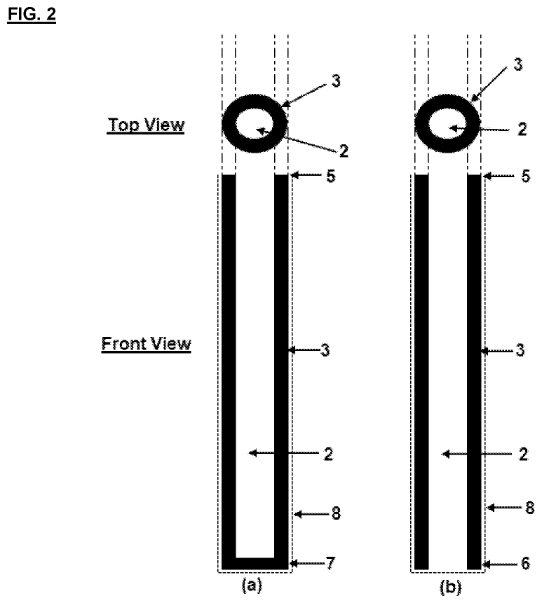

The present art describes the method and the product that benefits both environment and society. FIG. 1 shows the development of composite cores 1 by replacing the surrounding soil 4. FIG. 2 shows the injected plant-based matter into the borewell of desert/drought soil. The plant-based matters are injected into two different separate layers and resulted in the formation of a cellulosic biomass pulp composite core 1. The cellulosic biomass pulp composite core 1 comprises of a central core portion 2 and a shell portion 3 surrounding central portion 2. The central core portion 2 is made up of a dense cellulosic biomass pulp consisting of about 70-100% cellulose, 0-10% hemicellulose, and 0-10% lignin. The central portion 2 retains moisture. The shell portion 3 is made up of a cellulosic biomass pulp enriched in a phenolic compound consisting of about 20-40% cellulose, about 0-10% hemicellulose, and 40-80% of phenolic compounds. The shell portion 3 minimizes interaction of the central core portion 2 with the surrounding soil 4 of the wasteland.

The composition of the central core portion 2 which is made up of a dense cellulosic biomass pulp has high cellulose content and demonstrates hydrophilic properties. Whereas the composition of the shell portion 3 which is made up of the cellulosic biomass pulp enriched in a phenolic compound demonstrates hydrophobic properties. Under the demonstrated structures of the cellulosic biomass pulp composite core 1, this can be achieved in two different ways—(a) composite core 1 structure with the formation of the bottom base 7, and (b) composite core 1 structure with the formation of the bottom end 6 (without base). As the bottom base 7 is made up of the same material composition as that of the shell portion 3, the structure of the composite core 1 with the bottom base 7 reduces the loss of water at the bottom of the soil. Whereas the structure of the composite core 1 with the bottom end 6 (without base) helps to grow plants and trees with the formation of inter and intra-connected root systems between different borewell grown plants and trees. Both structures of the composite core 1 have importance in reducing the heat index of the land surface while supporting the plant growth during the biochemical transformation of desert/drought soil into stable land. However, the composite core 1 structure without the bottom end 6 (without base) helps to convert earthquake-prone zones into stable regions due to inter and intra-connected root systems underneath the surrounding soil 4.

Agricultural, non-agricultural, and forestry biomass are potential feedstock to produce the central core portion 2 made up of a dense cellulosic biomass pulp, and the shell portion 3 made up of cellulosic pulp enriched in phenolic compounds. Furthermore, the composition of lignocellulosic feedstock consisting of 10-45% cellulose, 10-45% hemicellulose, and 15-35% phenolic compounds (and/or lignin) is ideal for the production of the dense cellulosic biomass pulp for the central core portion 2. Examples include sugarcane bagasse, sweet sorghum bagasse, switchgrass, corn stalks & cob, softwood, and hardwood are named a few. Whereas the composition of lignocellulosic feedstock consists of 0-35% cellulose, 0-20% hemicellulose, and 1-80% phenolic compounds are ideal to produce the shell portion 3 consisting of cellulosic pulp enriched in phenolic compounds. Examples include leaves, spent coffee beans, spent tea leaves, pinecones, wood bark, rice hull, and nutshells are named a few.

For the explanatory purpose, sugarcane bagasse is used to produce the dense cellulosic biomass pulp (for a central core of the borewell), whereas spent tea leaves are used to produce the cellulose pulp enriched in phenolic compounds (for a shell portion of the borewell).

To generate dense cellulosic biomass pulps for the central core portion 2, a combination of alkaline pH extraction followed by acid pH extraction is applied. The alkaline pH extraction named modified ethyl-hydro-oxides (m-EHOs) consists of ethanol in an amount of 10-90% by volume, potassium hydroxide (KOH) in an amount of 1-20% by weight, potassium carbonate (K₂CO₃) in an amount of 0-20% by weight, hydrogen peroxide (H₂O₂) in an amount of 1-20% by weight, nitrogen (N₂) in an amount of 0-80% by volume, hydrogen (H₂) in an amount of 0-20% by volume, and seawater/water (H₂O) in an amount of 20-60% by weight, to the 40-98% of the total volume of the reactor. The ratio of biomass to the modified ethyl-hydro-oxides (m-EHOs) solvent is maintained between 1:50 to 1:1 by weight over volume. The process operates at a temperature of 65° C.-75° C. and a pressure of 400-800 psi for 1-8 hours. The process removes the phenolic compounds and decreases the crystallinity of lignocellulosic biomass such as sugarcane bagasse. At the end of the process, the reactor contents cooled down to the temperature of −10° C. to 25° C. for pH neutralization. The pH neutralization can be performed using hydrochloric acid, citric acid, and acetic acid. After separating the liquid fraction from the solid fraction from the generated biomass slurry, followed by water washing, the holocellulose is generated. The composition of generated holocellulose using sugarcane bagasse consists of 60-85% cellulose, 10-20% hemicellulose, and 5-15% lignin. In another embodiment, cellulose pulp for the central core development of the borewell can be replaced with holocellulose pulp.

In the continuation, the generated holocellulose is utilized in the mild sulfuric acid extraction to generate the cellulose pulp. The mild sulfuric acid extraction process consists of acid concentration in a range of 0.1-5% of the total weight of holocellulose (dry basis) to remove the hemicellulose fraction of holocellulose wherein a ratio of biomass to solvent ranges between 1:1-1:10, operating conditions involve an operating temperature of 60-100° C. for 1-2 hours with the introduction of pressurized carbon dioxide (CO₂) in a range of 0-600 psi. At the end of the process, the reactor contents are pH neutralized followed by water washing to generate cellulose pulp. The composition of generated cellulose pulp consists of 70-100% cellulose, 0-10% hemicellulose, and 0-10% lignin. The detailed description of the process is explained in the U.S. patent application Ser. No. 17,727,705.

To generate cellulose pulp enriched in phenolic compounds, an alkaline pH solvent consisting of ammonium hydroxide (NH₄OH) is utilized with the ground spent tea leaves. The ground spent tea leaves were generated following hot water extraction (at 40-80° C. for a few minutes) followed by milling and grinding. The resulted ground spent tea leaves consists of 10-25% cellulose, 1-5% hemicellulose, and 60-80% phenolic compounds. To generate cellulose pulp enriched in phenolic compounds, the ground spent tea leaves were added to the ammonium hydroxide solution (in L) in a ratio of 1:1-1:50. The concentration of ammonium hydroxide in the slurry can vary between 1-30% (by weight) at the operating temperature of 20-200° C. for the processing period of 1 hour to 24 hours. For instance, the ground spent tea leaves were chemically extracted with 7.5 wt. % NH₄OH for 6 hours to 12 hours at 65° C. using the biomass and solvent ratio of 1:10 (weight/volume). The purpose of the ammonium hydroxide extraction is meant to remove partial content of phenolic compounds while decreasing the crystallinity of ground spent tea leaves and generating the reactive sites on phenolic compounds. At the end of the process, the most of ammonium hydroxide is recovered through heating in the range of 30-100° C., followed by cooling of the reactor contents at the temperature of −10-25° C. for the pH neutralization. The pH neutralization can be performed using hydrochloric acid, citric acid, and acetic acid. Following the pH neutralization, the generated biomass slurry is separated into solid and liquid fractions using a vibrational screen to retain the swollen biomass content. The biomass composition of ammonium hydroxide extracted ground spent tea leaves consists of 20-40% cellulose, 0-10% hemicellulose, and 40-80% phenolic compounds. It has been observed that the pulp of ground spent tea leaves on heating at the temperature of 40-80° C. for 1-6 days, solidifies into a matter harder than a rock. In another embodiment, cellulose pulp enriched in phenolic compounds can be utilized in the development of water pipeline infrastructures over the conventional water pipelines using iron and steel.

In other embodiment, the technologies that can generate cellulose pulp/holocellulose pulp (for the central core portion 2 of the composite core 1) and cellulose pulp enriched in phenolic compounds (for the shell portion 3 of the composite core 1) are not limited to alkaline pH (such as ethyl-hydro-oxides (EHOs), alkaline hydroxide (NaOH, KOH, Ca(OH)₂, NH₄OH), alkaline-peroxide, Ionic liquids), acidic pH (sulfuric acid, phosphoric acid, H₂O₂, anthraquinone), and neutral pH (warm, hot, and superheated water) based solvent processes.

In another embodiment, both cellulose pulp (for the central core portion 2 of the composite core 1) and cellulose pulp enriched in phenolic compounds (for the shell portion 3 of the composite core 1) are further treated with carbonated water and/or carbon dioxide at the controlled temperature of 0-60° C. The solubility of carbon dioxide ranges between 3.25 g of CO₂ per kg of water (at 0° C.) to 0.6 g of CO₂ per kg of water (at 60° C.). The temperature-controlled decarbonization leads to zero-carbon emission. In the continuation, carbon dioxide can be generated through different resources including capturing of atmospheric carbon dioxide, industrial effluent, and microbial systems (including anaerobic fermentation). Similarly, different water resources through desalination, freshwater (using lakes or rivers), and processed water (using industrial processes) can be utilized to produce carbonated water. It should also be noted that the production of pulps and carbonated water takes place at two distinct places before their combination. The purpose of the carbonated water at the optimum concentration in the composite core 1 is to support the maximum growth of the plant/tree through the root system and to decarbonize the excess atmospheric carbon dioxide.

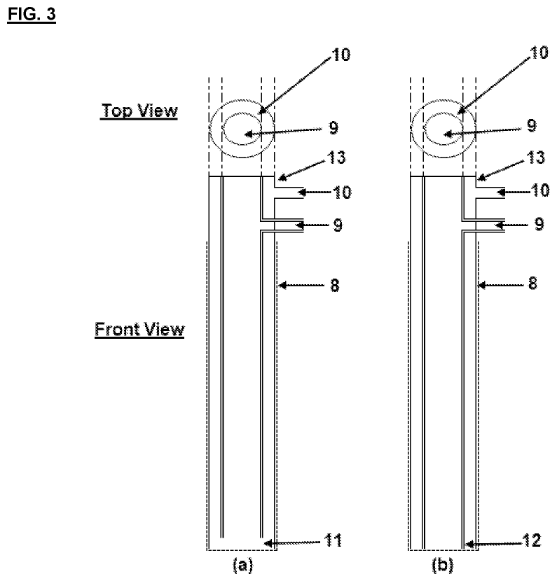

FIG. 3 shows the procedure of the injection of dense cellulosic biomass pulp and the cellulosic pulp enriched in phenolic compounds into a borewell 8 for landfilling with the composite core 1 with and without carbonated water for the transformation of desert/drought land into a stable region. The dense cellulosic biomass pulp is fed through the borewell tubing 13 having an inlet 9 for feeding a central core portion 2, and an inlet 10 for feeding a shell portion 3. Furthermore, the structure of the composite core structure can be created with the bottom base 11 and the bottom end 12. Different methods of borewell development can be utilized before stuffing different layers of pulps including soil/rock drilling (in case of hard soil as in drought land) and soil suction vacuum (in case of particulate soil as in desert soil) and/or the combination of both. Furthermore, the borewell filling can be assisted with the air compressor to transfer different pulps (cellulose pulp and cellulose pulp enriched with phenolic compounds) to the borewell. In the other embodiment, the generated soil (due to drilling or vacuum suction) can be utilized in the pulp modification. The soil of the wasteland is mixed with the dense cellulosic biomass pulp of the central core portion 2 and the cellulosic biomass pulp enriched in a phenolic compound of the shell portion 3 in a ratio of 1:1 to 1:10,000 either on-site or off-site of the operation.

The function of the shell portion 3 (the cellulose pulp enriched in phenolic compounds) is to minimize the interaction of the surrounding soil 4 of the wasteland with the central core portion 2 (cellulose/holocellulose pulp) of the borewell. During the process, the shell portion 3 solidifies over time while retaining the moisture-holding capacity of injected cellulose/holocellulose contents of the borewell 8. The functionality of the shell portion 3 can also be accomplished through the replacement with hydrophobic and/or water-resistant materials such as plastic, PVC, Iron, and steel are named a few. However, the implication of an alternative to cellulose pulp enriched in phenolic compounds confines the proliferation of microbial activity in the development of desert/drought soil into fertile soil.

The ability of dense cellulose pulp of the central portion 2 to retain the moisture content for a longer duration can be significantly affected by the soil properties (such as elements of soil content, calcium carbonate, gypsum, organic matters, pH, and dryness) in the absence of the shell portion 3. However, a limited quantity of soil can be added to the central core portion 2 and the shell portion 3 during the injection process of the pulps. Doing the suggested process, a limited amount of essential nutrients can be extracted from the soil itself while supporting the growth of plants/trees and decreasing the requirement for cellulosic pulps. Furthermore, the high alkalinity of the desert soil (up to pH of 8.5) can be utilized as a natural pH neutralizing agent during the processing of mild acid extraction pulp of modified ethyl-hydro-oxides (m-EHOs) process as described in the continuation of the U.S. patent application Ser. No. 17,727,705.

In another embodiment, the biomass pulp generated through two different extraction processes—modified ethyl-hydro-oxides (m-EHOs) and ammonium hydroxide have their importance in the desert/drought land modifications. The pH neutralization using hydrochloric acid and acetic acid in the pulps generated through modified EHOs (m-EHOs) and ammonium hydroxide resulted in the production of potassium chloride and ammonium acetate, respectively. The generated salts (potassium chloride and ammonium acetate) have importance in the growth of agricultural plants such as sugarcane.

In 2013, the top ten sugarcane cultivator countries (including Brazil, India, China, Thailand, Pakistan, Mexico, Colombia, Indonesia, Philippines, and the United States) had accounted for 2,165 million tons of sugarcane production using 26.5 million hectors of land. In India, the carbon dioxide released by sugarcane crops in the field and during processing accounted for 20.65 million tons with 228.89 million tons of carbon dioxide adsorption from the atmosphere during its life cycle. The cultivation of sugarcane requires an extended growth period (9 to 16 months), a warm sunny season (at 32-38° C. for germination, at 22-30° C. for optimum growth) with adequate moisture (5-6 mm water per day during the growth cycle or 1,500-2,500 mm water per total growing period), followed by a dry, sunny and cold temperature (at 10-20° C.) for ripening and harvesting. Sugarcane belongs to the C4 plant that converts up to 3.7-4.3% of the total incident solar energy into biomass. The roots of sugarcane spread up to 5 m under the soil. The sugarcane grows in soils with a pH of 5-8.5 with the optimum soil pH of 6.5. The cultivation of sugarcane requires a high quantity of both nitrogen and potassium with a relatively low phosphate content. Based on the geographical location, the productivity of sugarcane crops can vary between 50 tons/ha to 150 tons/ha. In Brazil, sugarcane productivity performs at 75 tons/ha. The distances between two rows of sugarcane vary between 2-2.5 m and the two consecutive plants (in the same raw) between 0.9-1 m. The average weight of a sugarcane stalk is more than 2 kg. Around 35 tons/ha of biomass is left over after sugarcane processing. In this residual biomass, sugarcane bagasse (after juice extraction) constitutes up to 300 kg (with 50% moisture content) in 1,000 kg of sugarcane crop. The chemical composition of sugarcane bagasse consists of 58-70% polysaccharides (wherein 38%-45% cellulose, and 20-25% hemicellulose) and 20-30% lignin contents of the total biomass.

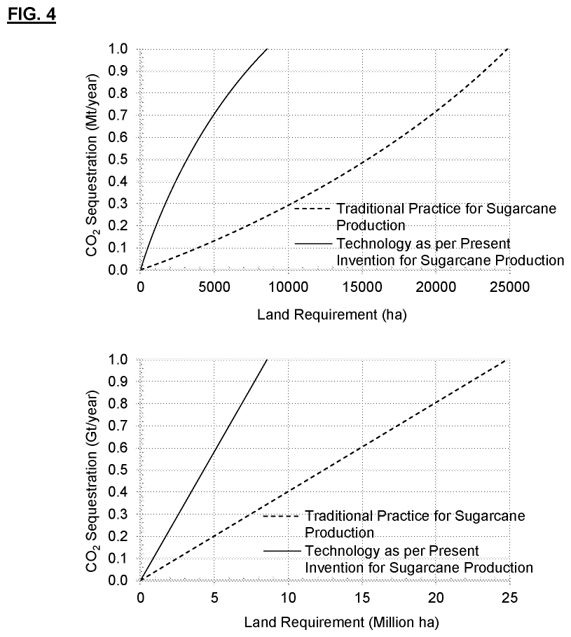

Based on the Earth formation and plant physiology theories, it is believed that 25 ha (0.25 km²) of vegetative land can sequester up to 1,000 tons of atmospheric carbon dioxide in a year using sugarcane farming or another lignocellulosic biomass with the current practice. Based on the current innovation, 8-9 ha of land can sequester up to 1,000 tons of atmospheric carbon dioxide. The difference in the current practice and the purposed innovation is due to the number of plantations (as shown in FIG. 4). For example, to produce a sugarcane crop, around 28,000 shoots can be planted in 0.25 ha of land considering the distance of 2 m between the two consecutive rows of plantation and the distance of 1 m between the two consecutive plants of the same row. The process involves up to 1.6 Mt of biomass (borewell diameter: 3 cm; borewell depth: 1.5 m) to 55 Mt of biomass (borewell diameter: 3 cm; borewell depth: 50 m) to convert 8 ha or more of desert/drought land into vegetative land in 3-6 months. It should also be noted that the fertility of the soil increases instantaneously on the injection and implication of carbonated water/water with plant matter. Furthermore, the effect of treated biomass has better moisture holding capability compared to untreated biomass. For instance, the combination of the alkaline pH process (using EHOs and/or modified—EHOs) followed by the acidic pH process (using mild sulfuric acid) removes up to 90% to 100% of phenolic compounds (due to alkaline pH) and 80% to 100% of hemicellulosic sugars (due to acidic pH) from plant and tree matter, respectively. The process combination (of alkaline pH and acidic pH) increases the moisture-holding capability up to 60% to 80% (or more) from 30% or more of biomass. Furthermore, the chemical processing of biomass increases the density of biomass (compared to untreated biomass) by 20% or more. The dense biomass (due to chemical treatment/treatments) has a critical role in the stabilization of borewells (by removing the void spaces) for the transformation of desert/drought soil into stable regions as purposed with the current invention. Furthermore, increasing the plantation increases the atmospheric carbon dioxide sequestration.

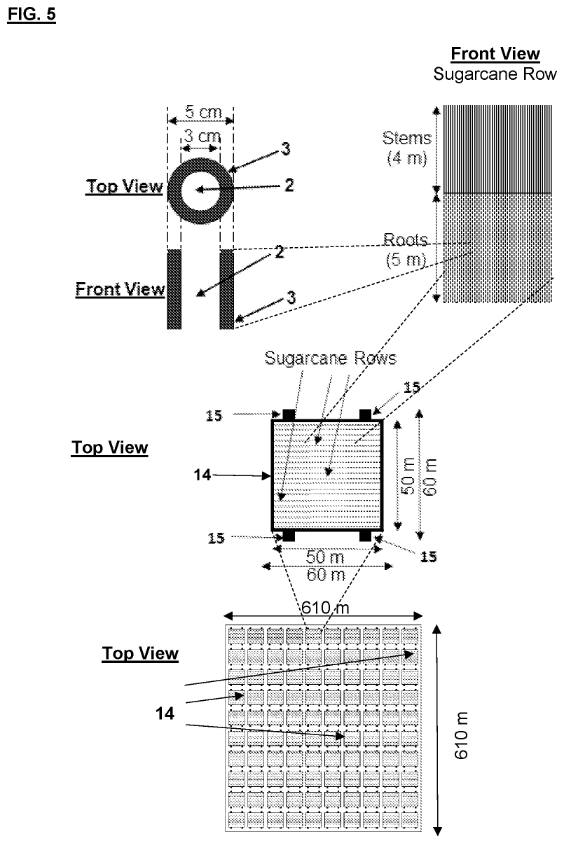

In another embodiment, to achieve the growth of plants/trees in harsh environmental conditions as in desert land (such as in the Sahara Desert), a mobile biosphere unit (MBU) 14 is formulated (as shown in FIG. 5). Here, a single mobile biosphere unit (MBU) 14 comprises a total area of 3600 m² with 2500 m² for vegetation. The construction of MBU 14 involves the use of a framework fitted with transparent glass and/or epoxy glass. A Mobile Biosphere Unit (MBU) 14 is attached with solar panels for temperature control and the mobility of vehicles with lifting operational capability 15 (up to 4 meters or higher). The development of the plurality of MBUs 14 for the total land area of 37.2 ha having a vegetative land area of 25 ha can sequester 3,000 tons of carbon dioxide through sugarcane plantation in a year. The simultaneous utilization of biomass in the process and production (through agriculture) would eliminate the supply chain differences over time of the process. The proposed process transforms a desert into farmland, sequesters atmospheric carbon dioxide through water dissolution, and thereby, helps in agriculture productivity, soil remediation (soil moisturizer and conditioner), increasing underground water-level, transforming earthquake-prone zones into stable regions, and sequestering atmospheric carbon dioxide.

The amount of biomass requirement for soil moisture depends on both the diameter and the depth of the borewell 8 on the land surface. For example, the bored hole with 3 cm in diameter and 1.5 m in length, the volume of 0.00106 m³ of soil need must be replaced with an equal amount of biomass. Here, biomass contains moisture up to 70%, and the density mainly due to cellulose is 1500 kg/m³ with an effective density of 1050 kg/m³. Based on the given data, the amount of biomass requirement is 1.1 kg/1.5 m deep hole. Similarly, the borewell with 3 cm in diameter and 5 m in length requires 0.00353 m³ of soil need to replace with 3.7 kg of biomass. In the continuation, the borewell with 3 cm in diameter and 20 m in length requires 0.01413 m³ of soil need to replace with 14.8 kg of biomass.

The present disclosure may be better understood concerning the examples provided below.

TABLE 1
Calculation for a borewell formation using sugarcane bagasse.
Borewell Dimensions

| | | | | | |
|---|---|---|---|---|---|
| Borewell Diameter (cm) | 3 | 3 | 3 | 3 | 3 |
| Borewell depth (m) | 1.5 | 5 | 10 | 20 | 50 |

Desert/Drought Soil

| | | | | | |
|---|---|---|---|---|---|
| Soil volume replacement per borewell (m³) | 0.001 | 0.003 | 0.007 | 0.014 | 0.035 |
| Density of desert soil (kg/m³) | 1800 | 1800 | 1800 | 1800 | 1800 |
| Amount of soil replacement (kg) | 1.9 | 6.4 | 12.7 | 25.4 | 63.6 |

Cellulose Pulp

| | | | | | |
|---|---|---|---|---|---|
| Density of cellulose (kg/m³) | 1500 | 1500 | 1500 | 1500 | 1500 |
| Density of water (kg/m³) | 1000 | 1000 | 1000 | 1000 | 1000 |
| Density of cellulose with 70% moisture (kg/m³) | 1150 | 1150 | 1150 | 1150 | 1150 |
| Amount of cellulose with 70% moisture | 1.2 | 4.1 | 8.1 | 16.2 | 40.6 |
| requirement (kg/borewell) | | | | | |
| Amount of cellulose (kg/borewell) | 0.4 | 1.2 | 2.4 | 4.9 | 12.2 |
| Amount of water (kg/borewell) | 0.9 | 2.8 | 5.7 | 11.4 | 28.4 |

Note:
1. The amount of cellulose pulp is represented as the amount of pulp considering both layers (i.e., the shell portion (for plant protection) and the central core portion (for plant growth)).
2. The density of cellulose/holocellulose/phenolic compounds rich in plant matter can be altered with the addition of soil.

TABLE 2
Amount of sugarcane bagasse requirement in developing
pulp for the transformation of desert soil into a stable zone.

| | | Borewell Dimensions | | | | |
|---|---|---|---|---|---|---|
| | | Borewell Diameter (cm) | | | | |
| | | 3 | 3 | 3 | 3 | 3 |
| Total | Vegetative | Borewell depth (m) | | | | |
| area | Land | 1.5 | 5 | 10 | 20 | 50 |
| (ha) | (ha) | Mt/year, 10⁶t | | | | |
| 0.4 | 0.25 | 0.05 | 0.17 | 0.34 | 0.68 | 1.7 |
| 0.7 | 0.5 | 0.10 | 0.34 | 0.68 | 1.4 | 3.4 |
| 1.5 | 1 | 0.20 | 0.68 | 1.4 | 2.7 | 6.8 |
| 3 | 2 | 0.41 | 1.4 | 2.7 | 5.5 | 14 |
| 6 | 4 | 0.82 | 2.7 | 5.5 | 11 | 27 |
| 12 | 8 | 1.6 | 5.5 | 11 | 22 | 55 |
| 15 | 10 | 2.0 | 6.8 | 14 | 27 | 68 |
| 37 | 25 | 5.1 | 17 | 34 | 68 | 171 |
| 74 | 50 | 10 | 34 | 68 | 136 | 341 |
| 149 | 100 | 20 | 68 | 136 | 273 | 682 |
| 298 | 200 | 41 | 136 | 273 | 546 | 1,365 |
| 744 | 500 | 102 | 341 | 682 | 1,365 | 3,412 |
| 1,488 | 1,000 | 205 | 682 | 1,365 | 2,730 | 6,825 |
| 2,976 | 2,000 | 409 | 1,365 | 2,730 | 5,460 | 13,650 |
| 5,952 | 4,000 | 819 | 2,730 | 5,460 | 10,920 | 27,299 |
| 11,904 | 8,000 | 1,638 | 5,460 | 10,920 | 21,839 | 54,598 |
| 14,880 | 10,000 | 2,047 | 6,825 | 13,650 | 27,299 | 68,248 |
| 29,760 | 20,000 | 4,095 | 13,650 | 27,299 | 54,598 | 136,496 |
| 59,520 | 40,000 | 8,190 | 27,299 | 54,598 | 109,197 | 272,992 |
| 119,040 | 80,000 | 16,379 | 54,598 | 109,197 | 218,393 | 545,983 |
| 148,800 | 100,000 | 20,474 | 68,248 | 136,496 | 272,992 | 682,479 |

Note:
28,000 shoots per 2,500 m².

TABLE 3
Amount of water (carbonated and/or non-carbonated) requirement
(without irrigation) in the transformation of desert/drought soil
into a stable region.

| | | Borewell Dimensions | | | | |
|---|---|---|---|---|---|---|
| | | Borewell Diameter (cm) | | | | |
| | Vege- | 3 | 3 | 3 | 3 | 3 |
| Total | tative | Borewell depth (m) | | | | |
| area | area | 1.5 | 5 | 10 | 20 | 50 |
| (ha) | (ha) | Mt/year, 10⁶t | | | | |
| 0.4 | 0.25 | 0.024 | 0.080 | 0.159 | 0.318 | 0.796 |
| 0.7 | 0.5 | 0.048 | 0.159 | 0.318 | 0.637 | 1.59 |
| 1.5 | 1 | 0.096 | 0.318 | 0.637 | 1.27 | 3.18 |
| 3.0 | 2 | 0.191 | 0.637 | 1.27 | 2.55 | 6.37 |
| 6.0 | 4 | 0.382 | 1.27 | 2.55 | 5.10 | 13 |
| 12 | 8 | 0.764 | 2.55 | 5.10 | 10 | 25 |
| 15 | 10 | 1.0 | 3.18 | 6.37 | 13 | 32 |
| 37 | 25 | 2.4 | 7.96 | 16 | 32 | 80 |
| 74 | 50 | 4.8 | 16 | 32 | 64 | 159 |
| 149 | 100 | 9.6 | 32 | 64 | 127 | 318 |
| 298 | 200 | 19 | 64 | 127 | 255 | 637 |
| 744 | 500 | 48 | 159 | 318 | 637 | 1,592 |
| 1,488 | 1,000 | 96 | 318 | 637 | 1,274 | 3,185 |
| 2,976 | 2,000 | 191 | 637 | 1,274 | 2,548 | 6,370 |
| 5,952 | 4,000 | 382 | 1,274 | 2,548 | 5,096 | 12,740 |
| 11,904 | 8,000 | 764 | 2,548 | 5,096 | 10,192 | 25,479 |
| 14,880 | 10,000 | 955 | 3,185 | 6,370 | 12,740 | 31,849 |
| 29,760 | 20,000 | 1,911 | 6,370 | 12,740 | 25,479 | 63,698 |
| 59,520 | 40,000 | 3,822 | 12,740 | 25,479 | 50,958 | 127,396 |
| 119,040 | 80,000 | 7,644 | 25,479 | 50,958 | 101,917 | 254,792 |
| 148,800 | 100,000 | 9,555 | 31,849 | 63,698 | 127,396 | 318,490 |

TABLE 4
Relationship between the sequestration of atmospheric carbon
dioxide and increasing agricultural productivity.
Based on the given data (in India)

| | |
|---|---|
| India area (ha) | 328,726,300 |
| Total CO₂ production (Mt) | 208.24 |
| Sugarcane cropland area (ha) | 2,100,000 |
| Total CO₂ sequestration by sugarcane crop (Mt) | 84.58 |
| CO₂ sequestration (%) | 40.62 |
| Sugarcane Productivity (t/ha) | 77.3 |
| Total CO₂ sequestration by sugarcane crop (t/ha/year) | 40.28 |
| Total number of Sugarcane Stalk (Stalks/ha) | 38,650 |

Traditional Agriculture (Current use)

| | |
|---|---|
| No of Sugarcane Stalks (Stalks/ha) | 38,650 |
| Carbon Dioxide Sequestration (kg/stalk/year) | 1.04 |
| Net CO₂ removal (kg/ha/year) | 40,276 |
| Land Area for 1 t of CO₂ Sequestration (ha) | 0.025 |
| Land Area for 1000 t of CO₂ Sequestration (ha) | 25 |
| Land Area for 1 Mt of CO₂ Sequestration (ha) | 24,829 |
| Land Area for 1 Gt of CO₂ Sequestration (ha) | 24,828,565 |

Technology as per Present Invention

| | |
|---|---|
| No of Sugarcane Stalks (Stalks/ha) | 112,000 |
| Carbon Dioxide Sequestration (kg/stalk/year) | 1.04 |
| Net CO₂ removal (kg/ha/year) | 116,712 |
| Land Area for 1 t of CO₂ Sequestration (ha) | 0.009 |
| Land Area for 1000 t of CO₂ Sequestration (ha) | 9 |
| Land Area for 1 Mt of CO₂ Sequestration (ha) | 8,568 |
| Land Area for 1 Gt of CO₂ Sequestration (ha) | 8,568,072 |

It will be appreciated that the foregoing examples, given for purposes of illustration, are not to be construed as limiting the scope of this disclosure. Although only a few exemplary embodiments have been described in detail above, those skilled in the art will readily appreciate that many modifications are possible in the exemplary embodiments without materially departing from the novel teachings and advantages of this disclosure. Accordingly, all such modifications are intended to be included within the scope of this disclosure which is defined in any following claims and all equivalents thereto. Further, it is recognized that many embodiments may be conceived that do not achieve all the advantages of some embodiments, yet the absence of a particular advantage shall not be construed to necessarily mean that such an embodiment is outside the scope of the present disclosure.

What is claimed is:

1. A method for biochemical transformation of wasteland into farmland comprising of:
a waste landfilling by a plurality of cellulosic biomass pulp composite cores 1 using an appropriate method characterized in that wherein the cellulosic biomass pulp composite core 1 is comprised of a central core portion 2 for moisture retention and a shell portion 3 surrounding the central core portion 2 for minimizing interaction of the central core portion 2 with a surrounding soil 4 of the wasteland
wherein
the central core portion 2 is made up of a dense cellulosic biomass pulp consisting of about 70-100% cellulose, 0-10% hemicellulose, and 0-10% lignin, and
a shell portion 3 is made up of a cellulosic biomass pulp enriched in phenolic compounds consisting of about 20-40% cellulose, about 0-10% hemicellulose, and 40-80% of phenolic compounds.

2. The method for biochemical transformation of wasteland into farmland as claimed in claim 1, wherein pH of the dense cellulosic biomass pulp of the central core portion 2 and the cellulosic biomass pulp enriched in phenolic compounds of the shell portion 3 is in a range of 5-6.5.

3. The method for biochemical transformation of wasteland into farmland as claimed in claim 1, wherein dimensions of the cellulosic biomass pulp composite core 1 is decided based on a water requirement for the growth of a plant.

4. The method for biochemical transformation of wasteland into farmland as claimed in claim 1, wherein a volumetric ratio of the central core portion 2 to the shell portion 3 of the cellulosic biomass pulp composite core 1 is 1:1-100:1.

5. The method for biochemical transformation of wasteland into farmland as claimed in claim 1, wherein the cellulosic biomass pulp composite core 1 is having constant or varying cross-section area of any cross-section shape.

6. The method for biochemical transformation of wasteland into farmland as claimed in claim 1, wherein the plurality of cellulosic biomass pulp composite cores 1 is filled into the wasteland with its top-end surface 5 in alignment with a soil surface.

7. The method for biochemical transformation of wasteland into farmland as claimed in claim 1, wherein the dense cellulosic biomass pulp of the central core portion 2 and the cellulosic biomass pulp enriched in phenolic compounds of the shell portion 3 is treated with carbonated water and/or carbon dioxide at the controlled temperature of 0-60° C.

8. The method for biochemical transformation of wasteland into farmland as claimed in claim 1, wherein the dense cellulosic biomass pulp of the central core portion 2 is replaced with a holocellulose pulp consisting of 60-85% cellulose, 10-20% hemicellulose, and 5-15% lignin.

9. The method for biochemical transformation of wasteland into farmland as claimed in claim 1, wherein the cellulosic biomass pulp composite cores 1 is made up of only the dense cellulosic biomass pulp of the central core portion 2.

10. The method for biochemical transformation of wasteland into farmland as claimed in claim 1, wherein the cellulosic biomass pulp enriched in phenolic compounds of the shell portion 3 is replaced with a hydrophobic and/or water-resistant materials such as plastic, PVC, Iron, and steel.

11. The method for biochemical transformation of wasteland into farmland as claimed in claim 1, wherein the soil of the wasteland is mixed with the dense cellulosic biomass pulp of the central core portion 2 and the cellulosic biomass pulp enriched in phenolic compounds of the shell portion 3 in a ratio of 1:1 to 1:10,000.

12. The method for biochemical transformation of wasteland into farmland as claimed in claim 1, wherein the cellulosic biomass pulp composite cores 1 is provided with a bottom base 7 for reducing loss of water from a bottom end surface of the composite core 1 to the surrounding soil 4.

13. The method for biochemical transformation of wasteland into farmland as claimed in claim 1, wherein the cellulosic biomass pulp composite cores 1 is provided with bottom end 6 (without base) for the formation of inter and intra-connected root systems of the plants and trees grown between different borewells to convert earthquake-prone zones into stable regions due to inter and intra-connected root systems underneath the surrounding soil 4.

14. The method for biochemical transformation of wasteland into farmland as claimed in claim 1, wherein different nutrient contents such as ammonium acetate and potassium chloride are provided through cellulose pulp (in the central core portion 2 of the composite core 1) and cellulose pulp enriched in phenolic compounds (in the shell portion 3 of the composite core 1).

15. The method for biochemical transformation of wasteland into farmland as claimed in claim 1, wherein different chemical treatments including and not limited to alkaline pH (such as ethyl-hydro-oxides (EHOs), alkaline hydroxide (NaOH, KOH, Ca(OH)₂, NH₄OH), alkaline-peroxide, Ionic liquids), acidic pH (sulfuric acid, phosphoric acid, H₂O₂, anthraquinone), and neutral pH (warm, hot, and superheated water) based solvent processes are used for the production of the plurality layers of the composite core 1.

16. The biochemical transformation of wasteland into farmland as claimed in claim 1, wherein a lignocellulosic feedstock with a composition of 10-45% cellulose, 10-45% hemicellulose, and 15-35% phenolic compounds (and/or lignin) is used for producing the dense cellulosic biomass pulp for the central core portion 2 of the composite core 1.

17. The biochemical transformation of wasteland into farmland as claimed in claim 1, wherein a lignocellulosic feedstock with a composition of 0-35% cellulose, 0-20% hemicellulose, and 1-80% phenolic compounds are used for producing the cellulosic pulp enriched in phenolic compounds for the shell portion 3 of the composite core 1.

18. The biochemical transformation of wasteland into farmland as claimed in claim 1, wherein cellulose pulp enriched in phenolic compounds can be utilized in the development of water pipeline infrastructures over the conventional water pipelines using iron and steel.
